(19) United States
(12) Patent Application Publication
(10) Pub. No.: US 2024/0416381 A1
(43) Pub. Date: Dec. 19, 2024

(54) POWDER COATING DEVICE

(71) Applicant: Panasonic Intellectual Property Management Co., Ltd., Osaka (JP)

(72) Inventors: TOSHIYUKI KOJIMA, Kyoto (JP); AKIHIRO HORIKAWA, Osaka (JP); SHUZO TSUCHIDA, Nara (JP)

(21) Appl. No.: 18/818,661

(22) Filed: Aug. 29, 2024

Related U.S. Application Data
(63) Continuation of application No. PCT/JP2022/045208, filed on Dec. 8, 2022.

(30) Foreign Application Priority Data
Mar. 11, 2022 (JP) 2022-037965

(51) Int. Cl. B05C 11/02; H01M 4/04

(52) U.S. Cl. CPC B05C 11/023; H01M 4/0404

(57) ABSTRACT

A powder coating device includes first-stage squeegee (11) and second-stage squeegee (12) that adjust a thickness of supplied powder (3), in which first-stage squeegee (11) and second-stage squeegee (12) vibrate at a natural frequency at a frequency from 2 kHz to 300 kHz inclusive, and second-stage squeegee (12) is shifted from first-stage squeegee (11) by a quarter wavelength of the natural frequency in a width direction of powder (3) supplied to a surface of sheet (4).

### TECHNICAL FIELD

The present disclosure relates to a powder coating device.

### BACKGROUND ART

In recent years, a dry coating method of directly coating powder has attracted attention as a method that enables a powder layer having high performance and a small environmental load to be formed as compared with a wet coating method of dispersing powder in a solvent before coating. This is because, according to the dry coating method, a powder layer can be obtained, the powder layer being less damaged by the solvent, maintaining high performance, not requiring drying of the solvent, and greatly reducing the amount of energy consumed.

As a method of performing the dry coating of the powder, conventionally, a technique is widely known in which a surface of a member such as a metal foil is coated with powder while conveying the member.

For example, PTL 1 discloses a technique of applying powder onto a surface of a long metal foil. PTL 1 describes that the powder is applied onto the surface of the metal foil, and thereafter, the powder is leveled by a squeegee to uniformly adjust a thickness of a powder layer. FIG. 5 is a view illustrating squeegee 26 of conventional powder coating device 21, and FIG. 6 is a view illustrating squeegee 26 of conventional powder coating device 21 as viewed from above and a view illustrating applied powder layer 25 as viewed from the front. Part (a) of FIG. 6 is a diagram illustrating a case where squeegee 26 vibrates at a natural frequency with a sinusoidal standing wave (illustrated as viewed from the front) when squeegee 26 is viewed from above. Furthermore, part (b) of FIG. 6 is a view illustrating powder layer 25 applied to sheet 24 when viewed from the front.

As illustrated in FIG. 5, squeegee 26 vibrates at high frequency in the vicinity of the ultrasonic band (a frequency from 2 kHz to 300 kHz inclusive), and the vibration is transmitted to powder 23 to improve the fluidity of powder 23, and thus, coating without powder clogging can be realized.

As illustrated in part (a) of FIG. 6, when squeegee 26 is vibrated at high frequency, squeegee 26 vibrates with a sinusoidal standing wave due to vibration at the natural frequency. As a result, as illustrated in part (b) of FIG. 6, powder layer 25 having passed through a gap of squeegee 26 has an uneven structure scraped in a sinusoidal standing wave shape.

### CITATION LIST

### Patent Literature

PTL 1: Unexamined Japanese Patent Publication No. 2021-178271

### SUMMARY OF THE INVENTION

A powder coating device of the present disclosure includes: a drive device that moves a member in a predetermined direction; a powder supply device that supplies powder to a surface of the member; and a first squeegee and a second squeegee that are disposed to provide a clearance between the member and each of the first squeegee and the second squeegee and adjust a thickness of the powder supplied to the surface of the member by the powder supply device, in which the first squeegee and the second squeegee vibrate at a natural frequency at a frequency from 2 kHz to 300 kHz inclusive, the first squeegee is located closer to a supply side of the powder than the second squeegee is, and the second squeegee is shifted from the first squeegee by a quarter wavelength of the natural frequency along a width direction of the powder supplied to the surface of the member.

### BRIEF DESCRIPTION OF THE DRAWINGS

FIG. 1 is a schematic view of a powder coating device according to an exemplary embodiment of the present disclosure.

FIG. 2 is a schematic view illustrating a part of the powder coating device and a powder layer according to the exemplary embodiment of the present disclosure.

FIG. 3 is a schematic view illustrating a part of the powder coating device and the powder layer according to the exemplary embodiment of the present disclosure.

FIG. 4 is a schematic view illustrating a part of the powder coating device according to the exemplary embodiment of the present disclosure.

FIG. 5 is a schematic view illustrating a part of a conventional powder coating device.

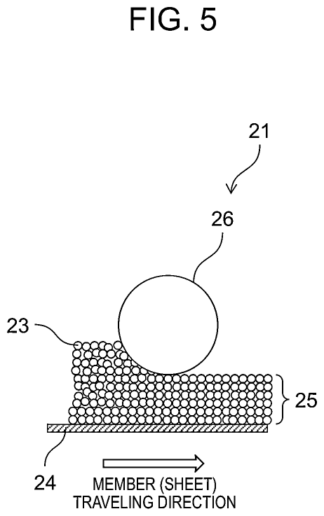

FIG. 6 is a schematic view illustrating a part of the conventional powder coating device and a powder layer.

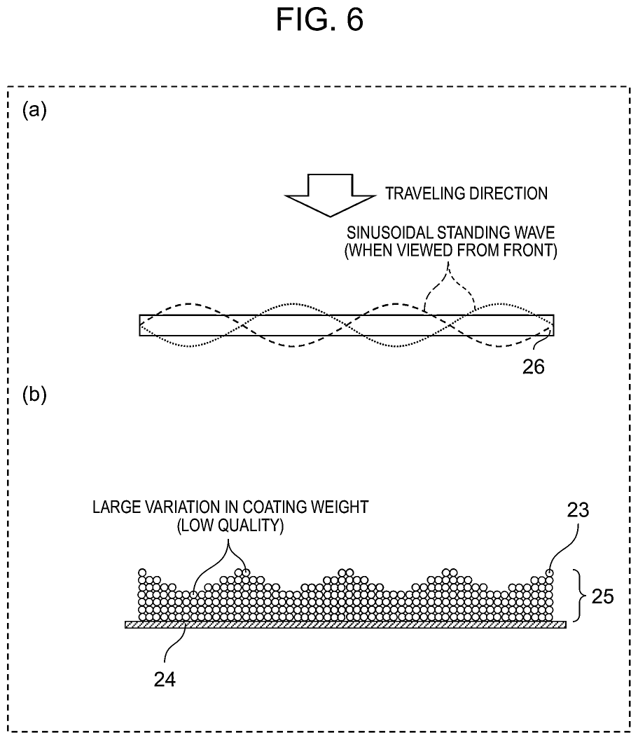

### DESCRIPTION OF EMBODIMENT

In the technique disclosed in Patent Literature 1, there is room for improvement in a case where variation in coating weight in the coating width direction occur in the powder layer and uniformity is required.

An object of the present disclosure is to provide a powder coating device that can reduce variation in the coating weight caused by an uneven structure in which a surface of a powder layer is scraped in a sinusoidal standing wave shape.

Note that the exemplary embodiment described below is intended to provide comprehensive or specific examples of the present disclosure. Numerical values, shapes, materials, constituent elements, disposition positions and connection modes of the constituent elements, steps, order of the steps, and the like illustrated in the exemplary embodiment below are merely examples, and are not intended to limit the present disclosure. Further, among the constituent elements in the following exemplary embodiment, constituent elements not recited in the independent claims are described as optional constituent elements.

Further, each of the drawings is a schematic view, and is not necessarily illustrated precisely. In the drawings, identical reference marks are given to the identical components.

### (Overview)

The powder coating device of the present disclosure includes a drive device that moves a member in a predetermined direction, a powder supply device that supplies powder to a surface of the member, and a plurality of squeegees that are disposed to provide clearances (hereinafter, also referred to as gaps) between the member and each of the plurality of squeegees and adjust a thickness and a coating weight of the powder supplied to the surface of the member by the powder supply device. In addition, the plurality of squeegees vibrates at the natural frequency at a frequency from 2 kHz to 300 kHz inclusive. In a case where the plurality of squeegees includes a first squeegee and a second squeegee, the first squeegee is located closer to the powder supply side than the second squeegee. The second squeegee is shifted from the first squeegee by a quarter wavelength at the time of vibration at the natural frequency along the width direction of the powder supplied to the surface of the member.

With this configuration, the first squeegee and the second squeegee vibrate at high frequency in the vicinity of the ultrasonic band (a frequency from 2 kHz to 300 kHz inclusive), and the vibration is transmitted to the powder to improve the fluidity of the powder, and thus, coating without powder clogging can be realized.

In addition, when the first squeegee and the second squeegee are vibrated at high frequency, the first squeegee and the second squeegee vibrate at the natural frequency with a sinusoidal standing wave. This causes the surface of the powder layer that has passed through the gap between the first squeegee and the member and the gap between the second squeegee and the member to have a shape scraped in a sinusoidal standing wave shape. Therefore, by adopting a device configuration in which the second squeegee is shifted by a quarter wavelength of the natural frequency with respect to the first squeegee and the first squeegee and the second squeegee are aligned in the traveling direction in two stages, the second squeegee can scrape a portion with a large coating weight after scraping with the first squeegee. As a result, the variation in the coating weight of the powder layer in the width direction can be reduced.

Hereinafter, an exemplary embodiment of the present disclosure is described with reference to the drawings.

### Exemplary Embodiment

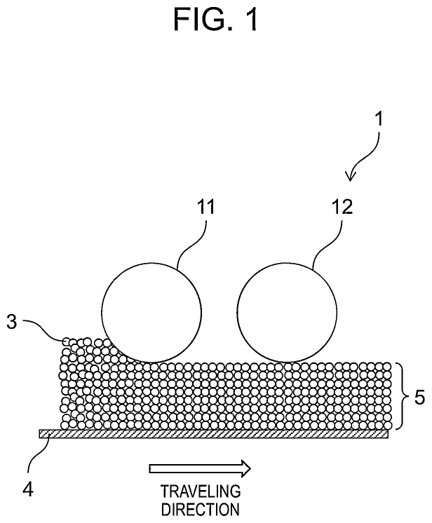

Hereinafter, the exemplary embodiment is described with reference to FIGS. 1 to 4.

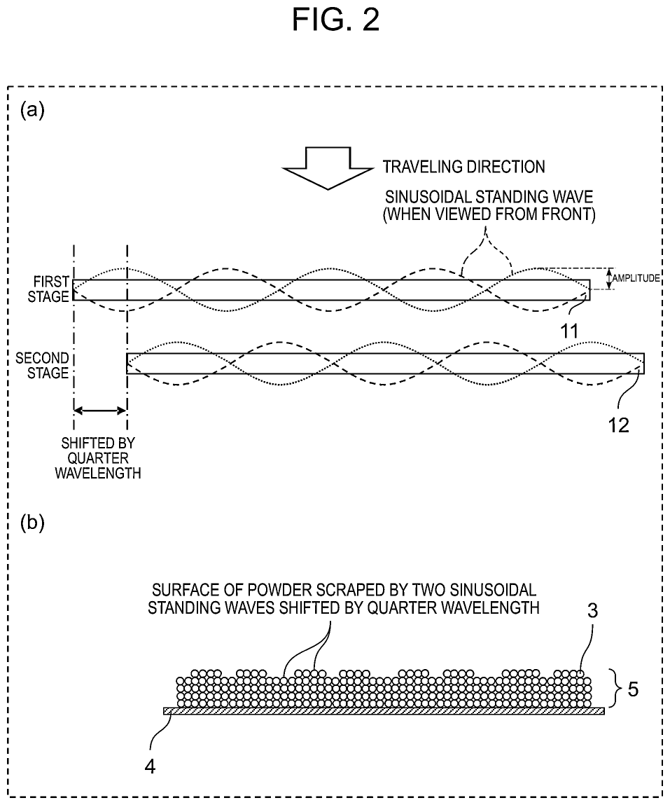

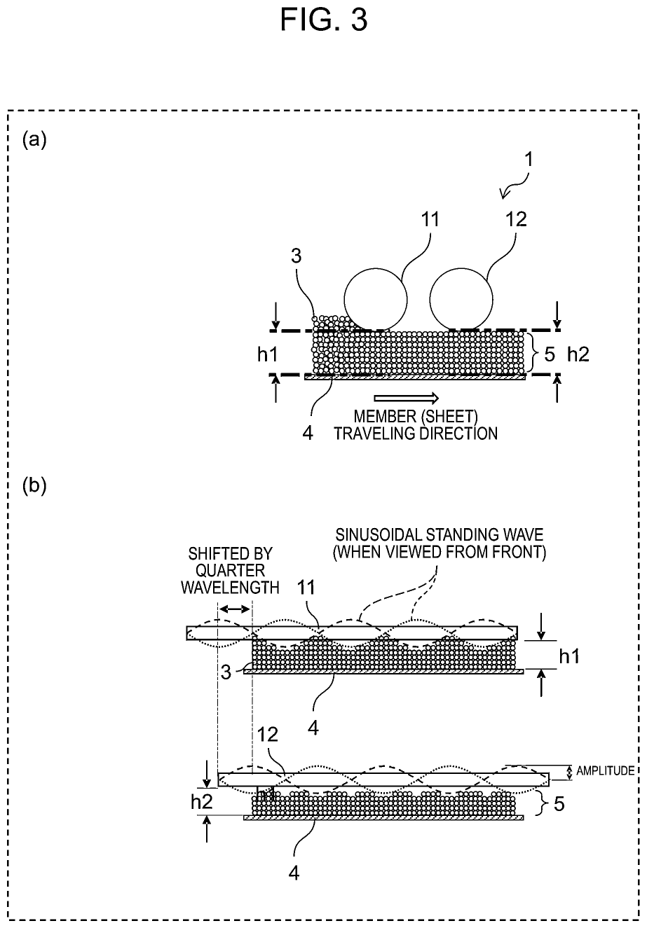

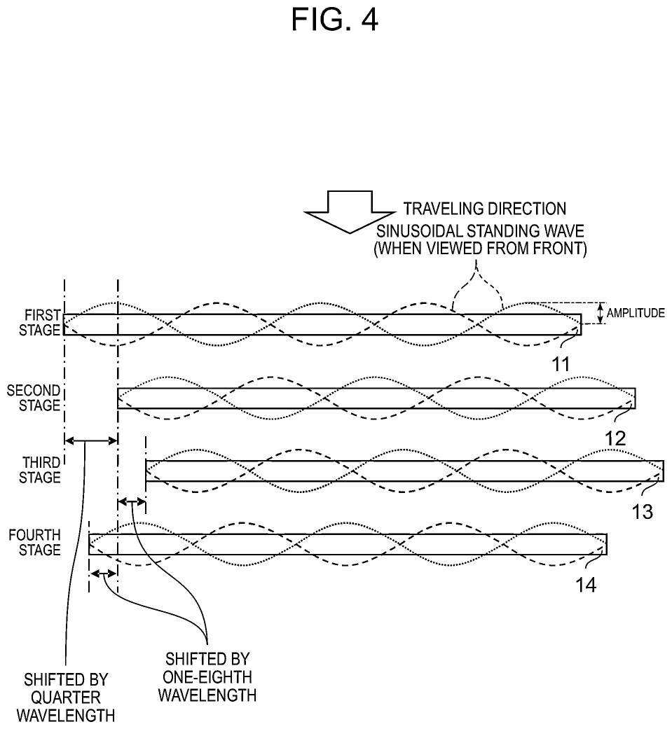

FIG. 1 is a schematic view illustrating powder coating device 1 according to the exemplary embodiment of the present disclosure, FIGS. 2 and 3 are schematic views illustrating a part of powder coating device 1 according to the exemplary embodiment of the present disclosure and powder layer 5, and FIG. 4 is a schematic view illustrating a part of powder coating device 1 according to the exemplary embodiment of the present disclosure. Part (a) of Fig. is a view illustrating a case where first-stage squeegee 11 and second-stage squeegee 12 vibrate at a natural frequency with a sinusoidal standing wave (illustrated as viewed from the front) when first-stage squeegee 11 and second-stage squeegee 12 are viewed from above. Furthermore, part (b) of FIG. 2 is a view illustrating a case where powder layer 5 applied to sheet 4 is viewed from the front. Part (a) of FIG. 3 is a view illustrating a case where first-stage squeegee 11, second-stage squeegee 12, and powder layer 5 are viewed from the side. Furthermore, (b) of FIG. 3 is a view illustrating a case where first-stage squeegee 11, second-stage squeegee 12, and powder layer 5 applied to sheet 4 are viewed from the front. Furthermore, FIG. 4 is a view illustrating a case where first-stage squeegee 11, second-stage squeegee 12 third-stage squeegee 13, and fourth-stage squeegee 14 vibrate at a natural frequency with a sinusoidal standing wave (illustrated as viewed from the front) when first-stage squeegee 11, second-stage squeegee 12 third-stage squeegee 13, and fourth-stage squeegee 14 are viewed from above.

### [Powder Coating Device]

As illustrated in FIG. 1, the powder coating device 1 includes a conveyance device (not illustrated) as a drive device, a powder supply device (not illustrated), first-stage squeegee 11 vibrating at high frequency, and second-stage squeegee 12 vibrating at high frequency. First-stage squeegee 11 is an example of a first squeegee. Second-stage squeegee 12 is an example of a second squeegee.

A sheet-like member (hereinafter, also referred to as sheet 4) is conveyed along a traveling direction by the conveyance device. The powder coating device 1 continuously supplies powder 3 to the surface of conveyed sheet 4 by using the powder supply device. Powder coating device 1 adjusts the film thickness and the filling rate of powder 3 supplied to the surface of sheet 4 by using first-stage squeegee 11 and second-stage squeegee 12, and reduces the variation in the coating weight while setting powder layer 5 to a desired coating weight.

Powder 3 is first adjusted by first-stage squeegee 11, and subsequently adjusted by second-stage squeegee 12.

Here, the coating weight is a value indicating the amount of powder per unit area by weight, and the unit of the coating weight is indicated by, for example, g/cm².

Note that the conveyance device is not particularly limited as long as sheet 4 can be conveyed, and any device may be used. The conveyance device may be, for example, a conveyance device that can continuously feed out sheet 4 wound in a roll, or a conveyance device that can intermittently feed out sheet 4.

Note that a guide roller that rotates with the movement of sheet 4, a control device that corrects the meandering of sheet 4, and the like may be provided on a conveyance path of sheet 4.

In the present exemplary embodiment, sheet 4 is a long belt-shaped thin plate and is wound in a roll. Note that sheet 4 is not limited to the long belt-shaped thin plate. For example, sheet 4 having a desired shape may be fed out from the conveyance device, and new sheet 4 may be fed out from the conveyance device after application of powder 3 to sheet 4 is completed. Furthermore, sheet 4 may not be wound in a roll shape. That is, sheet 4 only needs to have a shape that allows powder 3 to be applied thereto by using powder coating device 1. Therefore, a shape of sheet 4 is not particularly limited. In the present exemplary embodiment, sheet 4 is a current collector including a metal foil, but the material of the member is not particularly limited. That is, any member can be used as sheet 4 as long as the member can be coated with powder 3 by using powder coating device 1.

Powder 3 may be a powdery substance. That is, the raw material of powder 3, the composition of powder 3, and the particle shape of powder 3 are not particularly limited. In the present exemplary embodiment, powder 3 is a group of particles containing a solid electrolyte.

An average particle size (D50) of each particle of powder 3 is preferably from 0.005 μm to 30 μm inclusive. In this case, fluidity of powder 3 easily decreases, but stagnation and aggregation of powder 3 are suppressed by vibration of first-stage squeegee 11 and second-stage squeegee 12, so that powder layer 5 having a small variation in the coating weight can be formed. Note that the average particle size (D50) may be a volume-based median diameter calculated from a measurement value of particle size distribution by a laser diffraction and scattering method. The average particle size (D50) can be measured by using a commercially available laser analysis and scattering type particle size distribution measurement device.

In addition, powder 3 may contain only one type of powder or two or more types of powder.

In the present exemplary embodiment, a hopper is used as the powder supply device. The hopper stores powder 3 therein and supplies powder 3 to the surface of sheet 4. The hopper is disposed on the upstream side of first-stage squeegee 11 and second-stage squeegee 12 in the traveling direction of sheet 4. As sheet 4 moves, powder 3 supplied to the surface of sheet 4 reaches second-stage squeegee 12 via first-stage squeegee 11. In the present exemplary embodiment, the hopper is used as the powder supply device, but the present invention is not limited thereto, and a device that can supply powder 3 to the surface of sheet 4 may be used as the powder supply device.

A predetermined gap is formed between first-stage squeegee 11 and second-stage squeegee 12, and sheet 4. Powder 3 supplied to the surface of sheet 4 passes through the gap. When powder 3 passes the gap, first-stage squeegee 11 and second-stage squeegee 12 adjusts the film thickness of powder 3 supplied to the surface of sheet 4 to reduce the variation in the coating weight of powder layer 5.

### (High-Frequency Vibration in the Vicinity of the Ultrasonic Band)

First-stage squeegee 11 and second-stage squeegee 12 vibrate at a frequency from 2 kHz to 300 kHz inclusive. That is, first-stage squeegee 11 and second-stage squeegee 12 vibrate at high frequency in the vicinity of the ultrasonic band. Specifically, when powder 3 supplied to the surface of sheet 4 passes through the gap between each of first-stage squeegee 11 and second-stage squeegee 12 and sheet 4, first-stage squeegee 11 and second-stage squeegee 12 are vibrated at high frequency in the vicinity of the ultrasonic band to enhance the fluidity of powder 3 in powder layer 5. Therefore, powder clogging is suppressed.

The fluidity of powder 3 tends to increase as the frequency of vibration of first-stage squeegee 11 and second-stage squeegee 12 increases. Therefore, the fluidity of powder 3 can be sufficiently enhanced by vibrating first-stage squeegee 11 and second-stage squeegee 12 at a frequency of more than or equal to 2 kHz in the high frequency region in the vicinity of the ultrasonic band. Because the high frequency in the vicinity of the ultrasonic band is easily attenuated if the frequency is too high, the vibration of first-stage squeegee 11 and second-stage squeegee 12 is not easily transmitted to powder 3. However, if the frequency is less than or equal to 300 kHz, the fluidity of powder 3 can be sufficiently enhanced. When first-stage squeegee 11 and second-stage squeegee 12 vibrate at high frequency in the vicinity of the ultrasonic band, powder 3 in contact with first-stage squeegee 11 and second-stage squeegee 12 does not easily receive frictional resistance due to the powder pressure to cause the fluidity to be increased, and thus, the stagnation and aggregation of powder 3 are suppressed.

In addition, also for powder 3 located in the vicinity of first-stage squeegee 11 and second-stage squeegee 12, the frictional force between the powder particles decreases due to the vibration effect by first-stage squeegee 11 and second-stage squeegee 12 to cause the fluidity to be increased, and thus, the aggregation of powder 3 is suppressed.

With this configuration, even when powder 3 having a particle size of less than or equal to 30 μm and low fluidity is used, first-stage squeegee 11 and second-stage squeegee 12 that vibrate allow powder 3 to pass through the gap without stagnation or aggregation.

### (Natural Frequency of First-Stage Squeegee 11 and Second-Stage Squeegee 12, and Disposition of First-Stage Squeegee 11 and Second-Stage Squeegee 12)

When first-stage squeegee 11 and second-stage squeegee 12 are vibrated at high frequency in the vicinity of the ultrasonic band, first-stage squeegee 11 and second-stage squeegee 12 vibrate with a natural frequency (resonance state), and first-stage squeegee 11 and second-stage squeegee 12 vibrate with a sinusoidal standing wave.

As illustrated in part (a) of FIG. 2, when viewed from the front, first-stage squeegee 11 and second-stage squeegee 12 are disposed such that an antinode portion of the sinusoidal standing wave of first-stage squeegee 11 corresponds to a node portion of the sinusoidal standing wave of second-stage squeegee 12. In other words, first-stage squeegee 11 and second-stage squeegee 12 are disposed such that a node portion of the sinusoidal standing wave of first-stage squeegee 11 corresponds to an antinode portion of the sinusoidal standing wave of second-stage squeegee 12.

Specifically, first-stage squeegee 11 and second-stage squeegee 12 having the same shape are prepared and vibrated in the state at the same natural frequency. Here, the state at the same natural frequency is a state in which the positions of the antinode portion and the node portion correspond to each other at the same position. For example, this state can be realized by operating first-stage squeegee 11 and second-stage squeegee 12 at the same frequency. Specifically, this state can be realized by, in a state where first-stage squeegee 11 and second-stage squeegee 12 are aligned in parallel in this order along the traveling direction of powder layer 5, disposing second-stage squeegee 12 to be shifted in the width direction of powder 3, that is, in the width direction of powder layer 5 by a quarter wavelength of the natural frequency with respect to first-stage squeegee 11. The width direction of powder layer 5 is a direction orthogonal to the traveling direction.

With this configuration, as illustrated in part (b) of FIG. 2, coating with a small variation in the coating weight of powder layer 5 can be performed as compared with the conventional case. As a result, powder layer 5 with good quality can be formed.

The reason of the above is described. First, the surface of powder layer 5 is scraped off and coated with the shape of a sinusoidal standing wave by first-stage squeegee 11. The antinode portion of first-stage squeegee 11 vibrates more greatly than the node portion having substantially no amplitude of the sinusoidal standing wave. Therefore, powder layer 5 corresponding to the antinode portion is scraped more than powder layer 5 corresponding to the node portion when passing through the gap between first-stage squeegee 11 and sheet 4.

However, second-stage squeegee 12 scrapes a portion of powder layer 5 having a large powder coating weight after scraping with first-stage squeegee 11, that is, a portion of powder layer 5 having passed through the node portion of first-stage squeegee 11 (hereinafter, also referred to as a mountain portion). The mountain portion of powder layer 5 that have been scraped off supplements a portion having a small coating weight after scraping with first-stage squeegee 11, that is, a portion of powder layer 5 having passed through the antinode portion of first-stage squeegee 11 (hereinafter, also referred to as a valley portion). Therefore, coating with a small variation in the coating weight of powder layer 5 can be performed.

In addition, the magnitude of amplitude of first-stage squeegee 11 and second-stage squeegee 12 preferably has a relationship of: first-stage squeegee 11≥second-stage squeegee 12. That is, the amplitude of first-stage squeegee 11 is more than or equal to the amplitude of second-stage squeegee 12. This is because by setting the amplitude of second-stage squeegee 12 equal to the amplitude of first-stage squeegee 11, or setting the amplitude of second-stage squeegee 12 smaller than the amplitude of first-stage squeegee 11, the coating result of first-stage squeegee 11 is not completely reset. With this configuration, the variation in the coating weight of powder layer 5 can be reduced by the action of both first-stage squeegee 11 and second-stage squeegee 12.

Furthermore, the amplitude of second-stage squeegee 12 is preferably one quarter to three quarters of the amplitude of first-stage squeegee 11. By setting the amplitude of second-stage squeegee 12 to one quarter to three quarters of the amplitude of first-stage squeegee 11, second-stage squeegee 12 scrapes the mountain portion of powder layer 5 remaining after first-stage squeegee 11, and powder 3 scraped from the mountain portion is supplemented to the valley portion of powder layer 5. With this configuration, the mountain portion after scraping and the valley portion after supplement become well balanced. As a result, the variation in the coating weight of powder layer 5 can be further reduced.

Hereinafter, a gap between first-stage squeegee 11 and second-stage squeegee 12, and sheet 4 is described

As illustrated in part (a) of FIG. 3, assuming that a first gap between first-stage squeegee 11 and sheet 4 is h1 and a second gap between second-stage squeegee 12 and sheet 4 is h2, a relationship of h1≤h2 is preferably satisfied. That is, the first gap between first-stage squeegee 11 and sheet 4 is less than or equal to the second gap between second-stage squeegee 12 and sheet 4. This is because by setting the second gap of second-stage squeegee 12 equal to the first gap of first-stage squeegee 11, or setting the second gap of second-stage squeegee 12 wider than the first gap of first-stage squeegee 11, the coating result of first-stage squeegee 11 is not completely reset. With this configuration, the variation in the coating weight of powder layer 5 can be reduced by the action of both first-stage squeegee 11 and second-stage squeegee 12.

Furthermore, in a case where the amplitudes of the sinusoidal standing waves of first-stage squeegee 11 and second-stage squeegee 12 are set the same, the second gap of second-stage squeegee 12 is preferably wider than the first gap of first-stage squeegee 11 by one quarter to three quarters of the amplitude. By setting second-stage squeegee 12 wider than the amplitude of first-stage squeegee 11 by one quarter to three quarters, second-stage squeegee 12 scrapes the mountain portion of powder layer 5 remaining after first-stage squeegee 11, and powder 3 scraped from the mountain portion is supplemented to the valley portion of powder layer 5. With this configuration, the mountain portion after scraping and the valley portion after supplement become well balanced. As a result, the variation in the coating weight of powder layer 5 can be further reduced.

In addition, as illustrated in part (b) of FIG. 2, by scraping powder 3 in a portion having a large coating weight of powder layer 5 that has passed through the gap of first-stage squeegee 11 and the gap of second-stage squeegee 12 and by supplementing powder 3 to a portion having a small coating weight, the variation in the coating weight of powder layer 5 can be further reduced.

Note that a preliminary squeegee for roughly adjusting the thickness of powder layer 5 in advance may be provided in front of first-stage squeegee 11 (on the powder supply device side), and in the preliminary squeegee, the gap between the squeegee and the sheet may be widened on the front side (powder supply part side). This provides the stage of having the thickness of powder layer 5 roughly adjusted to have the coating weight adjusted, which is usually performed in order to reduce and adjust the coating weight while having the thickness of powder layer 5 thinned.

Furthermore, as illustrated in FIG. 4, third-stage squeegee 13 may be provided behind second-stage squeegee 12. That is, third-stage squeegee 13 may be disposed on the side opposite to the side of first-stage squeegee 11 with respect to second-stage squeegee 12. In this case, third-stage squeegee 13 is disposed to be shifted from second-stage squeegee 12 by one-eighth wavelength of the natural frequency in the width direction of powder 3, that is, along the width direction of powder layer 5. Third-stage squeegee 13 is an example of a third squeegee.

By disposing in this manner, third-stage squeegee 13 can scrape every other portion of powder layer 5 having a large coating weight, powder layer 5 having passed through the gap of first-stage squeegee 11 and the gap of second-stage squeegee 12, and powder 3 can be supplemented to a portion having a small coating weight.

Furthermore, fourth-stage squeegee 14 may be provided behind third-stage squeegee 13. That is, fourth-stage squeegee 14 may be disposed on the side opposite to the side of second-stage squeegee 12 with respect to third-stage squeegee 13. In this case, fourth-stage squeegee 14 is disposed to be shifted by one-eighth wavelength of the natural frequency with respect to second-stage squeegee 12 along the width direction of powder layer 5 so as to be in a direction opposite to the direction in which third-stage squeegee 13 is disposed to be shifted by one-eighth wavelength of the natural frequency with respect to second-stage squeegee 12. Fourth-stage squeegee 14 is an example of a fourth squeegee.

By disposing in this manner, fourth-stage squeegee 14 can scrape all the portion of powder layer 5 having a large coating weight, powder layer 5 having passed through the gap of first-stage squeegee 11 and the gap of second-stage squeegee 12, and powder 3 can be further supplemented to a portion having a small coating weight.

Specifically, first-stage squeegee 11, second-stage squeegee 12, third-stage squeegee 13, and fourth-stage squeegee 14 having the same shape are prepared, are vibrated at the natural frequency of the same frequency, and are disposed to be shifted from each other as described above.

### (Direction and Size of High-Frequency Vibration Near Ultrasonic Band, and Squeegee Shape)

The high-frequency vibration direction in the vicinity of the ultrasonic band of the squeegee includes at least one of a vertical component and a horizontal component. That is, the squeegee vibrates in at least one of the vertical direction and the horizontal direction. Note that the squeegee referred to herein collectively refers to first-stage squeegee 11, second-stage squeegee 12, third-stage squeegee 13, and fourth-stage squeegee 14 described above.

The vertical direction is a direction perpendicular to a main surface (surface on which the squeegee is in contact with the powder) of the squeegee. Regarding the vibration in the vertical direction, a longitudinal wave (wave in a vibration direction in which the squeegee approaches and separates from powder 3) is easily transmitted to powder 3.

The component in the vertical direction has a large effect on decrease in frictional resistance between particles of powder 3. This is because the vibration in the vertical direction is a vibration direction that the squeegee approaches and separates to and from powder 3, and thus, the collision between the particles of powders 3 is repeated, and the vibration is easily transmitted to powder 3. Because the high frequency in the vicinity of the ultrasonic band is high in frequency, there is a possibility that the vibration between the particles of powder 3 is difficult to be transmitted. However, the vibration in the vertical direction is easily transmitted particularly to powder 3.

Here, the horizontal direction is a direction parallel to the main surface of the squeegee and parallel to an axis of the squeegee. Regarding the vibration in the horizontal direction, a transverse wave (wave in a vibration direction in which the squeegee rubs against powder 3) is easily transmitted to powder 3. Here, the axis of the squeegee means an axis in a direction parallel to the width direction of sheet 4. The axis of the squeegee may be parallel to the longitudinal direction of the squeegee.

The horizontal component of high-frequency vibration in the vicinity of the ultrasonic band of the squeegee greatly contributes to decrease in frictional force between the squeegee and powder 3 in addition to decrease in frictional resistance between the particles of powders 3. If the vibration component in the vertical direction is too large, the vibration is excessively transmitted to powder 3, and powder 3 greatly vibrates to possibly cause the film thickness variation to increase. However, because the vibration component in the horizontal direction can also cause the frictional force between the squeegee and powder 3 to decrease, the fluidity of powder 3 can be particularly enhanced. Note that the vibration of the squeegee in the horizontal direction can be realized by attaching a high-frequency transducer in the axial direction of the squeegee and receiving the end of the squeegee by a bearing, and thus the device structure can be simplified as compared with the vibration in the plane direction.

The direction of the high-frequency vibration in the vicinity of the ultrasonic band of the squeegee may be only the vertical direction or only the horizontal direction. However, by using the high-frequency vibration in the vicinity of the ultrasonic band in both the vertical direction and the horizontal direction in combination, the fluidity of powder 3 can be further enhanced. For example, by focusing on one particle of powder 3, because the vibration direction of powder 3 becomes random and vibration is applied to the entire surface of powder 3, there is no surface where the vibration is not transmitted to cause the frictional resistance to increase, and thus, the fluidity of powder 3 is improved.

In a case where the squeegee vibrates at high frequency in the vicinity of the ultrasonic band in the vertical direction and the horizontal direction, the magnitude of vibration of the squeegee in the horizontal direction is preferably larger than the magnitude of vibration of the squeegee in the vertical direction. That is, in the squeegee, the magnitude of vibration of the transverse wave component of powder 3 (direction in which the squeegee rubs against and vibrates with respect to powder 3) is preferably larger than the magnitude of vibration of the longitudinal wave component of powder 3 (vibration direction in which the squeegee approaches and separates from powder 3). In this case, the frictional resistance particularly at the interface between the squeegee and powder 3 where the frictional resistance tends to be high can be reduced by the vibration of the squeegee in the horizontal direction, and the frictional resistance between the particles of powder 3 can also be reduced. Therefore, the fluidity of powder 3 can be further enhanced.

The magnitude of vibration of the squeegee in the vertical direction is preferably more than or equal to 2 μm. That is, the amplitude of the squeegee in the vertical direction is preferably more than or equal to 2 μm. In this case, the frictional resistance between the particles of powder 3 can be sufficiently reduced, and the fluidity of powder 3 can be further enhanced. In this case, the amplitude of the squeegee in the vertical direction is preferably less than or equal to 20 μm. With this configuration, powder 3 can be suppressed from being scattered as dust and contaminating the surroundings due to excessive vibration of powder 3.

The magnitude of vibration of the squeegee in the horizontal direction is preferably more than or equal to 4 μm. That is, the amplitude of the squeegee in the horizontal direction is preferably more than or equal to 4 μm. In this case, the frictional resistance at the interface between the squeegee and powder 3 can be sufficiently reduced, and the fluidity of powder 3 can be further enhanced. In this case, the amplitude of the squeegee in the horizontal direction is, for example, preferably less than or equal to 40 μm. With this configuration, powder 3 can be suppressed from being scattered as dust and contaminating the surroundings due to excessive vibration of powder 3.

The squeegee has, for example, a columnar shape, and is disposed such that, for example, an axial direction of the column (a height direction of the column) is parallel to the upper surface of sheet 4 and intersects (for example, is orthogonal to) the moving direction of sheet 4. The columnar squeegee is disposed by fixing both axial ends of the column of the squeegee with support columns with bearings so as to slide in the horizontal direction. A sliding amount in the horizontal direction can be adjusted by providing a stopper or the like in the squeegee. In addition, a shaft of the squeegee is formed in a shape that allows the shaft to be inserted into an aperture of the circular bearing, and the difference between the squeegee diameter and the bearing diameter is adjusted to enable the amount of vibration in the vertical direction to be adjusted. Therefore, a relationship in which the amplitude in the horizontal direction is larger than the amplitude in the vertical direction can be established.

### [Method for Manufacturing Powder Layer]

Hereinafter, a method for manufacturing powder layer 5 will be described. Powder layer 5 can be manufactured by using powder coating device 1.

The method for manufacturing powder layer 5 includes supplying powder 3 to the surface of sheet 4 such as a current collector while moving sheet 4 in a predetermined direction (a powder supply step), and adjusting the thickness and the coating weight of powder 3 supplied to the surface of sheet 4 by using first-stage squeegee 11 and second-stage squeegee 12 (a powder alignment step).

First, powder 3 is prepared. The raw material of powder 3 is not particularly limited, but for example, a group of particles containing an active material may be used. The active material is mixed with a binder added with an appropriate additive (for example, a conductive material) to prepare powder 3. Examples of the mixing method include a method of mixing with a mortar, a ball mill, a mixer, or the like. In particular, a method of mixing powder 3 without using a solvent or the like is preferable because the method does not cause material deterioration.

In the powder supply step, powder 3 is supplied to the surface of sheet 4 by using a powder supply device such as a hopper while sheet 4 is moved in a predetermined direction. Sheet 4 may have a shape other than the sheet shape, for example, a plate shape and a block shape. In this case, the plate and the block may be intermittently conveyed.

The powder alignment step is a step of aligning powder 3 on the surface of sheet 4 by using first-stage squeegee 11 and second-stage squeegee 12 of powder coating device 1. That is, in the powder alignment step, the thickness and the coating weight of powder 3 supplied to the surface of sheet 4 are adjusted by using first-stage squeegee 11 and second-stage squeegee 12. At this time, first-stage squeegee 11 and second-stage squeegee 12 vibrate at a frequency from 2 kHz to 300 kHz inclusive. First-stage squeegee 11 and second-stage squeegee 12 are disposed so as to have a positional relationship shifted by a quarter wavelength of the natural frequency with respect to the coating width direction.

The method for manufacturing powder layer 5 may further include a powder sheet formation step. The powder sheet formation step is a step of compressing powder 3 aligned on sheet 4 by using a roll press of powder coating device 1. With this configuration, a compressed powder layer obtained by compressing powder layer 5 is formed on the surface of sheet 4.

As described above, by performing the powder supply step and the powder alignment step in this order in the method for manufacturing powder layer 5, powder layer 5 including powder 3 is formed on the surface of sheet 4. Such a laminate of sheet 4 and powder layer 5 can be used for an energy device. For example, in a case where a current collector is used as sheet 4 and an active material is used as powder 3, an electrode for the energy device can be manufactured.

The energy device produced by using powder coating device 1 can provide powder layer 5 in which fluidity is imparted to powder 3 which is directly applied and the variation in the coating weight is small. Therefore, according to the method for manufacturing powder layer 5, because the step of directly applying powder 3 is used without using the step of dispersing powder 3 in the solvent or the like before application and then drying powder 3, deterioration of the material due to the solvent can be prevented and an increase in cost can be suppressed. In addition, because the coating weight of powder layer 5 is uniform, the quality as an electrode in the energy device can be improved, and an energy device having good quality can be manufactured at low cost.

Note that powder layer 5 may be a compressed powder layer further subjected to a roll press step.

### [Powder Layer]

Powder layer 5 of the energy device in one aspect of the present disclosure has a film thickness of more than or equal to 30 μm, the film thickness being provided on the current collector which is sheet 4. Further, powder layer 5 contains powder including at least one type of particle material. Furthermore, the concentration of the solvent contained in powder layer 5 is less than or equal to 50 ppm, and the variation in the coating weight is small.

With this configuration, powder layer 5 in which the variation in the coating weight is small and deterioration due to the solvent is suppressed is realized. In addition, because the solvent does not need to be dried, the energy consumption for drying the solvent can be reduced, and thus, the environmental load can be suppressed and the increase in manufacturing cost can be suppressed. Therefore, by using powder layer 5 as the energy device, the output power and quality of the energy device can be improved, the environmental load can be made small, and the cost can be reduced.

Powder layer 5 of the present exemplary embodiment can be used for, for example, an all-solid-state battery.

Hereinafter, powder layer 5 will be described in detail.

Powder layer 5 is formed on a current collector which is sheet 4. A powder layer composite is powder layer 5 of the energy device. For example, the powder layer composite is used as an electrode of the energy device or used in the all-solid-state battery. Note that the current collector may further include another layer positioned between the current collector and powder layer 5. Another layer is, for example, a connection layer including a conductive carbon material or the like.

Powder layer 5 has a film thickness of more than or equal to 30 μm. An upper limit value of the film thickness of powder layer 5 is not particularly limited, but is, for example, less than or equal to 2000 μm.

Further, powder layer 5 contains powder 3 including at least one type of particle material.

A concentration of the solvent contained in powder layer 5 is less than or equal to 50 ppm. That is, powder layer 5 does not substantially contain a solvent. Here, substantially does not include means not containing at all or inevitably containing less than or equal to 50 ppm as impurities or the like. The concentration of the solvent is a concentration on a weight basis.

The size of powder layer 5 in plan view is, for example, more than or equal to 30 mm×30 mm. An upper limit to the size of powder layer 5 in plan view is not particularly limited, but, for example, less than or equal to 300 mm×500 mm.

In an arbitrary region of 30 mm×30 mm on the surface of powder layer 5, the variation in the coating weight of powder layer 5 is less than or equal to 8%.

The coating weight is measured by, for example, the following method. First, powder layer 5 and the current collector are pressed from above and below to be compacted, and then, powder layer 5 and the current collector are punched into a circle having a diameter from 5 mm to 9 mm inclusive, and the total weight of punched powder layer 5 and the current collector is measured. Then, the weight of the current collector of the same lot punched out with a diameter from 5 mm to 9 mm inclusive, which is measured in advance, is subtracted from the total weight to determine the weight of powder layer 5. The coating weight can be obtained by dividing this weight by the area of a circle having a diameter from 5 mm to 9 mm inclusive.

Further, the variation in the coating weight is measured by, for example, the following method. First, an arbitrary region of 30 mm×30 mm on the surface of powder layer 5 in plan view is selected. This region may be a central region of the surface of powder layer 5 or a region including the end of powder layer 5. Then, within a range of this region, for example, five or more circles each having a diameter from 5 mm to 9 mm inclusive are punched, and the coating weight is measured using the above-described method. From the viewpoint of improving the measurement accuracy of the variation, nine or more places may be punched. The variation in the coating weight is calculated by dividing the difference (specifically, an absolute value of the difference) between an average of the coating weight of all the punched places and the coating weight of a place having the largest difference from the average among the coating weight of each punched place by the average. That is, the variation in the coating weight of less than or equal to 8% means that the difference of the coating weight from the average is less than or equal to 8% of the average at any punched place.

Although details will be described later, powder layer 5 is formed, for example, by applying high-frequency vibration to powder 3 supplied to the surface of sheet 4 to align the particles of powder 3 in powder layer 5 while fluidity is imparted to powder 3. Because the variation in the coating weight is small also in the width direction, powder layer 5 having a size of more than or equal to 30 mm×30 mm and a thickness of more than or equal to 30 μm can be produced with high quality. Therefore, powder layer 5 can be used for a large and high-capacity energy device.

In addition, powder layer 5 is produced through, for example, a coating step substantially free of a solvent. Thus, powder layer 5 substantially free of a solvent can be formed. For this reason, powder layer 5 is not damaged by the solvent. Therefore, because deterioration of powder layer 5 is suppressed, and the variation in the coating weight of powder 3 in powder layer 5 is small, powder layer 5 of a large and high capacity energy device having high output and excellent quality can be formed.

Furthermore, powder layer 5 can be used for, for example, a positive electrode, a negative electrode, or a solid electrolyte layer of an energy device such as an all-solid battery.

In a case where powder layer 5 is used for the positive electrode, for example, sheet 4 is a positive electrode current collector, and powder layer 5 containing powder 3 is a positive electrode mixture layer. That is, the positive electrode mixture layer is formed on the positive electrode current collector. Powder 3 in the positive electrode mixture layer contains a positive electrode active material and a solid electrolyte having ion conductivity as at least one type of particle material.

In a case where powder layer 5 is used for the negative electrode, for example, sheet 4 is a negative electrode current collector, and powder layer 5 containing powder 3 is a negative electrode mixture layer. That is, the negative electrode mixture layer is formed on the negative electrode current collector. Powder 3 in the negative electrode mixture layer contains a negative electrode active material and a solid electrolyte having ion conductivity as at least one type of particle material.

In a case where powder layer 5 is used as a solid electrolyte layer, for example, powder layer 5 containing powder 3 is a solid electrolyte layer. The solid electrolyte layer is formed on the surface of powder layer 5 in the positive electrode or the surface of the powder layer 5 in the negative electrode. Powder 3 in the solid electrolyte layer contains a solid electrolyte having ion conductivity as at least one type of particle material.

The concentration of the solvent contained in the positive electrode mixture layer, the negative electrode mixture layer, and the solid electrolyte layer is less than or equal to 50 ppm. That is, the positive electrode mixture layer, the negative electrode mixture layer, and the solid electrolyte layer are substantially free of a solvent. Here, substantially free of a solvent means a case where the above layers do not contain the solvent at all or a case where the above layers inevitably contains less than or equal to 50 ppm of the solvent as impurities or the like.

Note that the solvent is, for example, an organic solvent. The method of measuring the solvent is not particularly limited, and the solvent can be measured by using, for example, gas chromatography, a mass change method, or the like. Examples of the organic solvent include nonpolar organic solvents such as heptane, xylene, and toluene, polar organic solvents such as tertiary amine-based solvents, ether-based solvents, thiol-based solvents, and ester-based solvents, and combinations thereof. Examples of the tertiary amine-based solvent include triethylamine, tributylamine, and triamylamine. Examples of the ether-based solvent include tetrahydrofuran and cyclopentyl methyl ether. Examples of the thiol-based solvent include ethane mercaptan. Examples of the ester-based solvent include butyl butyrate, ethyl acetate, and butyl acetate.

Next, the materials used for the positive electrode mixture layer, negative electrode mixture layer, and the solid electrolyte layer will be described in detail.

The positive electrode active material is a material in which metal ions such as lithium (Li) are inserted into or removed from a crystal structure at a higher potential than the negative electrode, and oxidation or reduction is performed in association with insertion or removal of the metal ions such as lithium. The type of the positive electrode active material is appropriately selected according to the type of the all-solid-state battery, and examples thereof include an oxide active material and a sulfide active material.

As the positive electrode active material according to the present exemplary embodiment, for example, an oxide active material (lithium-containing transition metal oxide) is used. Examples of the oxide active material include LiCoO₂, LiNiO₂, LiMn₂O₄, LiCoPO₄, LiNiPO₄, LiFePO₄, LiMnPO₄, compounds obtained by substituting transition metal of these compounds with one or two different elements, and the like. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compounds obtained by substituting the transition metal of the above compounds with one or two different elements. One type or a combination of two or more types may be used as the material of the positive electrode active material.

Examples of the shape of the positive electrode active material include a particulate shape and a thin film shape. In a case where the positive electrode active material has a particulate shape, the particle size of the positive electrode active material is, for example, in a range from 50 nm to 30 μm inclusive, and may be in a range from 1 μm to 15 μm inclusive. If the particle size of the positive electrode active material is set to more than or equal to 50 nm, handling properties are easily improved. On the other hand, if the particle size is set to less than or equal to 30 μm, the surface area is increased by using an active material having a small particle size, and a positive electrode having a high capacity is easily obtained. Note that the particle size of the material contained in the positive electrode mixture layer or the negative electrode mixture layer in the present description is, for example, the average particle size (D50) described above.

The content of the positive electrode active material in the positive electrode mixture layer is not particularly limited, but may be, for example, from 40 wt % to 99 wt % inclusive, or from 70 wt % to 95 wt % inclusive.

The surface of the positive electrode active material may be coated with a coating layer. This is because the reaction between the positive electrode active material (for example, the oxide active material) and the solid electrolyte (for example, a sulfide-based solid electrolyte) can be suppressed. Examples of the material of the coating layer include Li-ion conductive oxides such as LiNbO₃, Li₃PO₄, and LiPON. The average thickness of the coating layer is, for example, in a range from 1 nm to 20 nm inclusive, and may be in a range from 1 nm to 10 nm inclusive.

Assuming that, in terms of weight, negative electrode active material/solid electrolyte=weight ratio, the ratio of the positive electrode active material and the solid electrolyte contained in the positive electrode mixture layer may be in a range from 1 to 19 inclusive, or in a range from 2.3 to 19 inclusive. By setting the weight ratio within this range, both a lithium ion conduction path and an electron conduction path in the positive electrode mixture layer are easily secured.

The negative electrode active material is a material in which metal ions such as lithium are inserted into or removed from a crystal structure at a lower potential than the positive electrode, and oxidation or reduction is performed in association with insertion or removal of the metal ions such as lithium.

As the negative electrode active material in the present exemplary embodiment, for example, known materials such as lithium, metal easily alloyed with lithium such as indium, tin, or silicon, a carbon material such as hard carbon or graphite, and oxide active material such as Li₄Ti₅O₁₂ or SiOₓ are used. In addition, as the negative electrode active material, a composite or the like obtained by appropriately mixing the above-described negative electrode active material may also be used.

The particle size of the negative electrode active material is, for example, less than or equal to 30 μm. By using an active material having a small particle size, the surface area is increased, and a high capacity can be achieved.

Assuming that, in terms of weight, negative electrode active material/solid electrolyte=weight ratio, the ratio of the negative electrode active material and the solid electrolyte contained in the negative electrode mixture layer may be in a range from 0.6 to 19 inclusive, or in a range from 1 to 5.7 inclusive. By setting the weight ratio within this range, both a lithium ion conduction path and an electron conduction path in the negative electrode mixture layer are easily secured.

The solid electrolyte may be appropriately selected according to the conductive ion species (for example, lithium ions), and for example, can be roughly categorized into a sulfide-based solid electrolyte, an oxide-based solid electrolyte, and a halide-based solid electrolyte.

The type of the sulfide-based solid electrolyte in the present exemplary embodiment is not particularly limited, and examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, from the viewpoint of excellent lithium ion conductivity, the sulfide-based solid electrolyte may contain Li, P, and S. One type or a combination of two or more types may be used as the material of the sulfide-based solid electrolyte. In addition, the sulfide-based solid electrolyte may be crystalline, amorphous, or glass ceramics. Note that, the above description of “Li₂S—P₂S₅” means a sulfide-based solid electrolyte obtained by using a raw material composition containing Li₂S and P₂S₅, and the same applies to other descriptions.

In the present exemplary embodiment, the sulfide-based solid electrolyte is, for example, a sulfide-based glass ceramic containing Li₂S and P₂S₅, and assuming that, in terms of mol, Li₂S/P₂S₅=mol ratio, a ratio between Li₂S and P₂S₅ may be in a range from 2.3 to 4 inclusive, or in a range from 3 to 4 inclusive. By setting the mol ratio within this range, a crystal structure having high ion conductivity can be obtained while a lithium concentration that influences battery characteristics is maintained.

Examples of the shape of the sulfide-based solid electrolyte according to the present exemplary embodiment include a particle shape such as a perfect spherical shape and an elliptical spherical shape, a thin film shape, and the like. In a case where the sulfide-based solid electrolyte material has a particle shape, the particle size of the sulfide-based solid electrolyte is not particularly limited, but may be less than or equal to 30 μm, less than or equal to 20 μm, or less than or equal to 10 μm because the filling rate in the positive electrode or the negative electrode is easily improved. Meanwhile, the particle size of the sulfide-based solid electrolyte may be more than or equal to 0.001 μm or more than or equal to 0.01 μm.

Next, the oxide-based solid electrolyte according to the present exemplary embodiment will be described. The type of the oxide-based solid electrolyte is not particularly limited, and examples thereof include LiPON, Li₃PO₄, Li₂SiO₂, Li₂SiO₄, Li_{0.5}La_{0.5}TiO₃, Li_{1.3}Al_{0.3}Ti_{0.7}(PO₄)₃, La_{0.51}Li_{0.34}TiO_{0.74}, and Li_{1.5}Al_{0.5}Ge_{1.5}(PO₄)₃. One type or a combination of two or more types may be used as the material of the oxide-based solid electrolyte.

Next, details of the positive electrode current collector and the negative electrode current collector will be described.

The positive electrode according to the present exemplary embodiment includes, for example, a positive electrode current collector made of a metal foil or the like. As the positive electrode current collector, for example, a foil-like body, a plate-like body, a mesh-like body, or the like made of aluminum, gold, platinum, zinc, copper, SUS, nickel, tin, titanium, or an alloy of two or more types thereof is used.

In addition, the thickness, shape, and the like of the positive electrode current collector may be appropriately selected according to the application of the positive electrode.

The negative electrode according to the present exemplary embodiment includes, for example, a negative electrode current collector made of a metal foil or the like. As the negative electrode current collector, for example, a foil-like body, a plate-like body, a mesh-like body, or the like made of SUS, gold, platinum, zinc, copper, nickel, titanium, tin, or an alloy of two or more types thereof is used.

In addition, the thickness, shape, and the like of the negative electrode current collector may be appropriately selected according to the application of the negative electrode.

Note that powder layer 5 may be a compressed powder layer obtained by pressing powder layer 5.

### EXAMPLES

Hereinafter, the present disclosure is specifically described with reference to examples. Note that the present disclosure is not limited to the examples described below.

In Example 1 to 2 and Comparative Example 1, the squeegee was set to have a columnar shape, simulation was performed at a vibration frequency of 2.5 kHz, and the variation in the coating weight of powder layer 5 after passing through the squeegee were analyzed.

Results are shown in Table 1 below.

In Example 1, second-stage squeegee 12 is disposed on the traveling direction side with respect to first-stage squeegee 11, and first-stage squeegee 11 and second-stage squeegee 12 are disposed to be shifted by a quarter wavelength of the natural frequency along the powder layer width direction.

In Example 2, in the configuration of Example 1, second-stage squeegee 12 was further vibrated so that the amplitude of second-stage squeegee 12 was half the amplitude of first-stage squeegee 11.

In Comparative Example 1, only first-stage squeegee 11 was used. Here, the variation in the coating weight in Table 1 is obtained by standardizing a value of the standard deviation of the coating weight distribution in the powder layer width direction with a value of Comparative Example 1. In addition, the amplitude was standardized with the amplitude of first-stage squeegee 11 as 1.

In Example 1, by adopting a configuration in which second-stage squeegee 12 is disposed to be shifted by a quarter wavelength of the natural frequency with respect to first-stage squeegee 11, stable coating with little variation in the coating weight can be performed. Further, in Example 2, by setting the amplitude of second-stage squeegee 12 to a half of that of first-stage squeegee 11, stable coating with less variation in the coating weight can be performed.

TABLE 1

| | | | Comparative |
|---|---|---|---|
| | Examples | | example |
| | 1 | 2 | 1 |
| Amplitude of first-stage squeegee | 1 | 1 | 1 |
| Amplitude of second-stage | 1 | 0.5 | None |
| squeegee | | | |
| Coating weight variation | Reduced | Reduced | Reference |
| | by 34% | by 72% | |

### (Other Modifications)

Although the powder coating device according to the present disclosure has been described above on the basis of the exemplary embodiment, the present disclosure is not limited to the above exemplary embodiment.

In addition, the present disclosure also includes a mode obtained by making various modifications conceivable by those skilled in the art to the above-described exemplary embodiment, and a mode realized by optionally combining constitutional elements and functions in the above-described exemplary embodiments without departing from the gist of the present disclosure.

According to the powder coating device of the present disclosure, a powder layer with high performance and low environmental load can be formed, the powder layer being reduced in the variation in the coating weight caused by an uneven structure in which the surface of the powder layer is scraped in a sinusoidal standing wave shape.

### INDUSTRIAL APPLICABILITY

The powder coating device of the present disclosure can be applied to applications such as a mixture layer of a high-quality all-solid-state battery by providing a uniform powder layer with little variation in film thickness without using a solvent.

### REFERENCE MARKS IN THE DRAWINGS

1 powder coating device
3 powder
4 sheet
5 powder layer
h1 gap between first-stage squeegee and sheet
h2 gap between second-stage squeegee and sheet
11 first-stage squeegee (first squeegee)
12 second-stage squeegee (second squeegee)
13 third-stage squeegee (third squeegee)
14 fourth-stage squeegee (fourth squeegee)

1. A powder coating device comprising:
a drive device that moves a member in a predetermined direction;
a powder supply device that supplies powder to a surface of the member; and
a first squeegee and a second squeegee that are disposed to provide a clearance between the member and each of the first squeegee and the second squeegee and adjust a thickness of the powder supplied to the surface of the member by the powder supply device, wherein
the first squeegee and the second squeegee vibrate at a natural frequency at a frequency from 2 kHz to 300 kHz inclusive,
the first squeegee is located closer to a supply side of the powder than the second squeegee is, and
the second squeegee is shifted from the first squeegee by a quarter wavelength of the natural frequency along a width direction of the powder supplied to the surface of the member.

2. The powder coating device according to claim 1, wherein
the first squeegee has an amplitude that is equal to or more than an amplitude of the second squeegee.

3. The powder coating device according to claim 1, wherein
the second squeegee and the member are separated from each other by a space of more than or equal to a space between the first squeegee and the member.

4. The powder coating device according to claim 1, further comprising
a third squeegee disposed on a side of the second squeegee opposite to a side on which the first squeegee is disposed, wherein
the third squeegee is disposed to be shifted from the second squeegee by one-eighth wavelength of the natural frequency along the width direction of the powder supplied to the surface of the member.

5. The powder coating device according to claim 4, further comprising
a fourth squeegee disposed on a side of the third squeegee opposite to a side on which the second squeegee is disposed, wherein
the fourth squeegee is disposed to be shifted from the second squeegee by one-eighth wavelength of the natural frequency along the width direction of the powder supplied to the surface of the member, the fourth squeegee being disposed in a direction opposite to a direction in which the third squeegee is disposed to be shifted from the second squeegee by one-eighth wavelength of the natural frequency.

6. The powder coating device according to claim 1, wherein
the powder has an average particle size (D50) from 0.005 μm to 30 μm inclusive.
